(19) United States
(12) Patent Application Publication
(10) Pub. No.: US 2015/0118901 A1
(43) Pub. Date: Apr. 30, 2015

(54) COAXIAL CABLE CONNECTOR HAVING A GRIPPING MEMBER WITH A NOTCH AND DISPOSED INSIDE A SHELL

(71) Applicant: Corning Gilbert Inc., Glendale, AZ (US)

(72) Inventor: Donald Andrew Burris, Peoria, AZ (US)

(73) Assignee: Corning Gilbert Inc., Glendale, AZ (US)

(21) Appl. No.: 14/086,595

(22) Filed: Nov. 21, 2013

Related U.S. Application Data
(60) Provisional application No. 61/896,355, filed on Oct. 28, 2013.

(51) Int. Cl. H01R 24/38; H01R 13/59

(52) U.S. Cl. CPC H01R 24/38; H01R 13/59
USPC 439/584

(57) ABSTRACT

A gripping member for a coaxial cable connector is disclosed. The gripping member has a front end and a rear end opposite the front end, and an outer surface and an inner surface defining a longitudinal hole extending between the front end and the rear end. A first portion of the gripping member terminates at the front end. A second portion of the gripping member terminates at the rear end and includes at least one notch which extends from the inner surface of second portion to a certain depth from inner surface. The gripping member is configured to be forced under a body of a coaxial cable connector when driven axially forward by a shell of a coaxial cable connector to secure a coaxial cable to the connector.

### RELATED APPLICATIONS

This application claims the benefit of priority under 35 U.S.C. 119 of U.S. Provisional Application Ser. No. 61/896,355 filed on Oct. 28, 2013, the content of which is relied upon and incorporated herein by reference in its entirety.

### BACKGROUND

1. Field

The disclosure relates generally to coaxial cable connectors, and particularly to coaxial cable connectors capable of being connected to a terminal.

2. Technical Background

Coaxial cable connectors such as F-connectors are used to attach coaxial cable to another object such as an appliance or junction having a terminal adapted to engage the connector. Coaxial cable F-connectors are often used to terminate a drop cable in a cable television system. The coaxial cable typically includes a center conductor surrounded by a dielectric, in turn surrounded by a conductive grounding foil and/or braid (hereinafter referred to as a conductive grounding sheath); the conductive grounding sheath is itself surrounded by a protective outer jacket. The F-connector is secured over the prepared end of the jacketed coaxial cable, allowing the end of the coaxial cable to be connected with a terminal block, such as by a threaded connection with a threaded terminal of a terminal block.

Securing an F-connector to a coaxial cable requires the application of a direct axial compression force to the F-connector. While a compound leverage compression tool is used in the field to enable technicians to secure the F-connector, it would be desirable for connector installers to have a coaxial connector requiring lower axial compression force but maintaining current functional standards such as environmental sealing, RF performance and mechanical performance.

### SUMMARY

Embodiments disclosed herein include a gripping member for a coaxial cable connector. The gripping member has a front end and a rear end opposite the front end, and an outer surface and an inner surface defining a longitudinal hole extending between the front end and the rear end. A first portion of the gripping member terminates at the front end. A second portion of the gripping member terminates at the rear end and includes at least one notch which extends from the inner surface of second portion to a certain depth from inner surface. The gripping member is configured to be forced under a body of a coaxial cable connector when driven axially forward by a shell of a coaxial cable connector to secure a coaxial cable to the connector.

Embodiments disclosed herein include a connector for coupling an end of a coaxial cable to a terminal. The coaxial cable has an inner conductor, a dielectric surrounding the inner conductor, an outer conductor surrounding the dielectric, a braided shield surrounding the dielectric, and a jacket surrounding the braided shield. The connector has a body, a shell, a post and a gripping member. The body has a rear end, a front end, and an internal surface extending between the rear and front ends of the body, the internal surface defining a longitudinal hole. The shell has a rear end, a front end surrounding at least a portion of the body, and an inner surface defining a longitudinal hole extending between the rear and front ends of the shell, the shell being axially movable over an outside portion the body between a rearward position and a forward position. The post is disposed at least partially within the longitudinal hole of the body, and has a rear end, an inner surface and an outer surface. The outer surface of the post and the internal surface of the post defines an annular cavity between the post and body, The gripping member is disposed within the longitudinal hole of the shell between the front and rear ends thereof and has a front end, a rear end, an outer surface, an inner surface defining an opening therein, a first portion adjacent the front end, and a second portion adjacent the rear end. The second portion has at least one notch which extends from the inner surface of second portion to a certain depth from inner surface. The gripping member is configured to secure a coaxial cable to a coaxial cable connector.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a side cutaway view of an exemplary embodiment of a connector, as disclosed herein, comprising a gripping member and a shell with a forward facing tapered portion in a rearward position.

FIG. 2 is a detail, front perspective view of an exemplary embodiment of the gripping member in the connector of FIG. 1;

FIG. 3 is a side cutaway view of the connector of FIG. 1 with a coaxial cable shown inserted and the gripping member and shell in a rearward position;

FIG. 4 is a side cutaway view of the connector of FIG. 3 with the gripping member and shell in the forward position;

FIG. 5 is a cross-section view of the connector of FIG. 4;

FIG. 6 is a detail, front perspective view of an exemplary embodiment of a gripping member;

FIG. 7 is a detail, front view of a gripping member with different types and geometries of notches;

FIG. 8 is a side cutaway view of an embodiment of a connector comprising a gripping member and a shell with a forward facing straight portion in a forward position;

FIG. 9 is a side cutaway view of the connector having an integral pin a gripping member and a shell with a forward facing tapered portion in a rearward position.

### DETAILED DESCRIPTION

Embodiments disclosed herein include a gripping member for a coaxial cable connector. The coaxial cable connector is used to connect a coaxial cable to an equipment port or terminal such that secure mechanical and electrical connections result. The terms “equipment port” and “terminal” may be used interchangeably herein. It should be understood that each of these terms shall mean or refer to any device or structure to which the coaxial cable connector attaches to mechanically and/or electrically connect a coaxial cable thereto. The coaxial cable connector includes attachment feature for attaching the coaxial cable connector to the equipment port or terminal. The attachment feature may be any suitable attachment device, including, without limitation, rotatable coupler, also referred to as a nut, or push-on component. A body is secured to the coupler at one end in a manner so that it does not rotate with coupler. A post is secured to and inside of the body. Shell is movably attached to body at another end such that shell can axially move toward coupler. Gripping member is frictionally fit inside of shell. Shell accepts the coaxial cable which is inserted through shell and gripping member and is secured to an end of post so that coaxial cable positions between post and body inside of body. Gripping member is configured to secure coaxial cable to coaxial cable connector. In this regard, when an axially compressive force is applied to shell to move shell axially toward coupler, gripping member also moves and at least a part of gripping member is forced between body and coaxial cable.

Gripping member has a front end and a rear end opposite the front end, and an outer surface and an inner surface defining a longitudinal hole extending between the front end and the rear end. A first portion of the gripping member terminates at front end. A second portion of the gripping member terminates at rear end and includes at least one notch which extends from inner surface of second portion to a certain depth from inner surface. The gripping member is configured to secure coaxial cable to coaxial cable connector. Gripping member secures coaxial cable to coaxial cable connector when at least part of the gripping member is forced under body. The gripping member may be forced under body of a coaxial cable connector when driven axially forward by shell to secure coaxial cable to the connector. When forced under the body, gripping member may be displaced radially inwardly, including, without limitation, the first portion and/or the second portion displaced radially inwardly.

Coaxial cable has a center or inner conductor that is surrounded by a dielectric layer. The dielectric layer (or dielectric) may also have a foil or other metallic covering. Coaxial cable then has a braided outer conductor which is covered and protected by a jacket. Typically, to prepare the coaxial cable for attachment to a coaxial cable connector, a portion of the center conductor is exposed. The jacket is trimmed back so that a portion of the dielectric (and metallic covering) and braided outer conductor are exposed. The braided outer conductor is then folded back over the jacket, to expose the dielectric (and the metallic covering if present). Whenever possible, the same reference numerals will be used throughout the drawings to refer to the same or like parts.

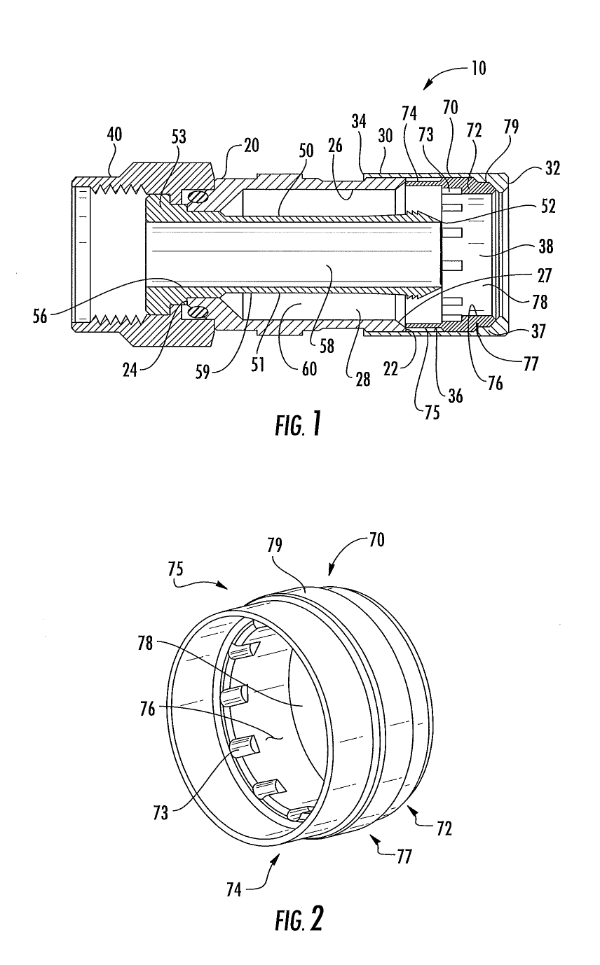

Referring now to the figures, FIG. 1 schematically illustrates an embodiment of connector 10 for coupling an end of a coaxial cable to a terminal (not shown). Connector 10 comprises body 20 with shell 30 disposed at rear end of body 20, coupler 40 disposed at, near or proximate front end of body 20, post 50 disposed at least partially within body 20, and gripping member 70 disposed between body 20 and shell 30. Gripping member 70 may be made from any suitable deformable material, such as plastic, for example acetal, or such as soft metal or alloy, for example lead. Body 20, shell 30, and coupler 40 may be made from any suitable material including a corrosion resistant material, for example nickel plated brass. Post 50 may be made from any suitable electrically conductive material, including a metal, for example tin-plated brass.

Body 20 comprises rear end 22, front end 24, and internal surface 26 extending between rear and front ends 22, 24 of body 20. Internal surface 26 defines longitudinal hole 28. Shell 30 comprises rear end 32, front end 34 surrounding and contacting body 20, and inner surface 36 defining longitudinal hole 38 extending between rear and front ends 32, 34 of shell 30.

Post 50 is disposed at least partially within longitudinal hole 28 of body 20. Post 50 comprises outer surface 59 and inner surface 56, wherein post 50 comprises flange 53 and tubular shank 51 having rear end 52, wherein at least rear end 52 is disposed within longitudinal hole 28 of body 20, and wherein outer surface 57 of tubular shank 51 and internal surface 26 of body 20 define an annular cavity 60 there between. Post 50 has inner surface 56, which defines longitudinal hole 58 extending from rear end 52 to front end 54.

Continuing to refer to FIG. 1, and now also, briefly to FIG. 2, which shows a perspective, detail view of gripping member 70, gripping member 70 is disposed to inner surface 36 of the shell 30. Gripping member 70 includes rear end 72 proximate rear end 32 of shell 30, front end 74 proximate body 20, outer surface 79 for contacting inner surface 36 of shell 30, and inner surface 76 defining longitudinal hole 78. Gripping member 70 has a first portion 75 that terminates at the front end 74 and a second portion 77 that terminates at the rear end 72. Additionally, gripping member 70 has at least one notch 73 extending from the inner surface 76 of second portion 77. In FIG. 2, a plurality of notches 73 is shown. Notches 73 extend to a certain depth in second portion 77 from inner surface 76. Although in FIG. 2 notches 73 do not extend through second portion 77 to outer surface 79, notches 73 may be constructed so as to extend from inner surface 76 to and/or through outer surface 79.

With reference to FIG. 1, shell 30 is axially moveable with respect to the body 20 between a rearward or disengaged position (to the right in FIG. 1) and forward or engaged position (to the left in FIG. 1). In FIG. 1, shell 30 is shown in rearward or disengaged position. When shell 30 is in the rearward position, front end 74 of gripping member 70 is aligned within the boundaries of rearward facing tapered portion 27 of rear end 22 of body 20. Front end 74 of gripping member 70 may contact rearward facing tapered portion 27 when shell 30 is in the rearward position, but that is not necessary. Rearward facing tapered portion 27 is configured to displace front end 74 of gripping member 70 radially inward. In this regard, front end 74 of gripping member 70 may contact rearward facing tapered portion 27 upon shell 30 moving forward. In this way, gripping member 70 may be maintained in concentric orientation with the longitudinal hole 28. However, as mentioned above, front end 74 of gripping member 70 need not contact rearward facing tapered portion 27. Alternatively or additionally, front end 74 of gripping member 70 could simply be disposed forward of rear end 22 of body 20. The rear end 72 of the gripping member 70 may be press fit with inner surface 36 of shell 30, i.e. the gripping member 70 is mounted onto inner surface 36 of shell 30 by press fit. In other embodiments, gripping member 70 may be mounted onto inner surface 36 of the shell 30 by adhesive.

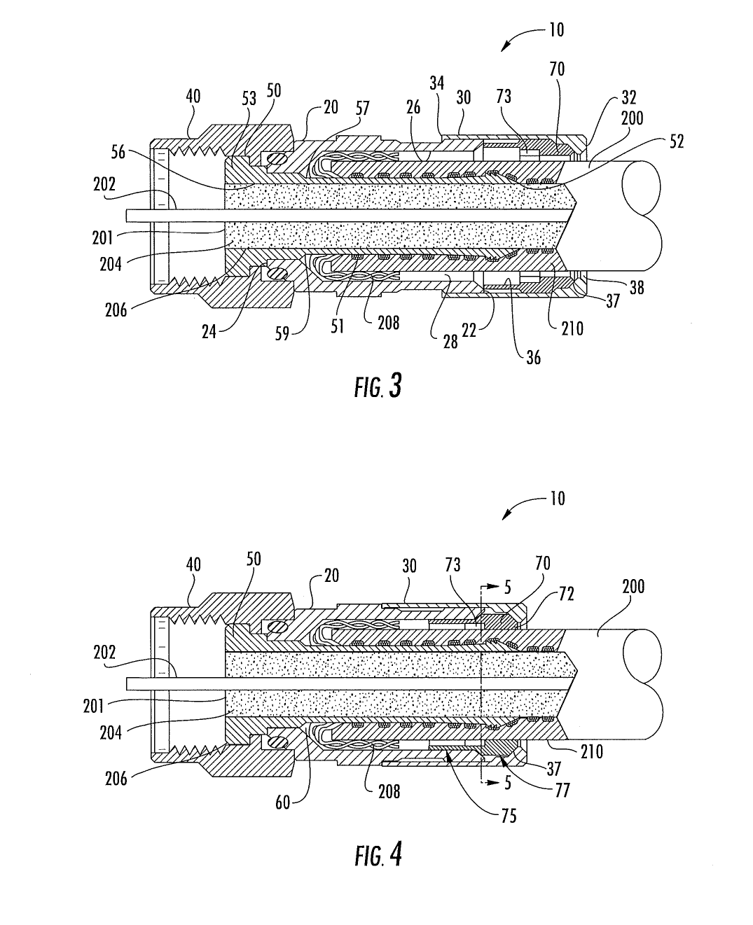

Referring now to FIGS. 3 and 4, coaxial cable 200 is shown inserted into connector 10. In FIG. 3, connector 10 is shown in disengaged position with shell 30 in a rearward position. In FIG. 4 connector 10 is shown in engaged position with shell 30 in the forward position. Disengaged position may also be referred to as the open position, while engaged position may also be referred to as the closed positioned. Coaxial cable 200 comprises an inner conductor 202, dielectric layer (or, simply, dielectric) 204 surrounding the inner conductor 202, outer conductor 206 and braided shield 208 surrounding the dielectric 204, and jacket 210 surrounding braided shield 208. Coaxial cable 200 enters connector 10 at rear end 32 of shell 30, passes through the longitudinal hole 78 of gripping member 70 and is fit onto rear end 52 of the shank 51 of post 50. Rear end 52 of post 50 is driven between braided shield 208 and outer conductor 206 of coaxial cable 200, until dielectric 204 at end 201 of cable 200 is flush with front end 54 of post 50. Inner conductor 202 and dielectric 204 insert in longitudinal hole 58 in post 50.

Referring in particularly now to FIG. 4, as shell 30 and post 50 are moved together axially by tool (not shown) front end 34 of shell 30 moves over an outside portion of body 20, causing gripping member 70 to move axially forward toward body 20 as well. First portion 75 of the gripping member 70 is displaced radially inward by interaction with rearward facing tapered portion 27 and first portion 75 is disposed in the annular cavity 60 between body 20 and post 50. As can be seen, first portion 75 of the gripping member 70 is fully disposed in the annular cavity 60, and even a portion of the second portion 77 of gripping member 70 may also be disposed within the annular cavity 60. Due to interaction with forward facing tapered portion 37 on the inside surface 36 of shell 30, gripping member 70 is pushed radially inward.

At least a portion of jacket 210 and braided shield 208 are sandwiched between the gripping member 70 and the rear end 52 of the post 50. It is also, that in the forward position, the gripping member 70 forms a seal between jacket 210 and rear end 22 of body 20, sealing annular cavity 60 at rear end 22 of body 20. Also, in the forward position, gripping member 74 forms a seal between the body 20 and the inner surface 36 of the shell 30. Both rear and front ends 72, 74 of gripping member 70 are displaced radially inwardly in the forward position forming a dual grip against jacket 210. Additionally, in the forward position, a portion of jacket 210 flows into one or more of notches 73.

Notches 73 in gripping member 70 result in gripping member 70 being more easily forced under body 20 when driven axially forward by shell 30. Accordingly, notches 73 lower the direct axial compressive force required to close connector 10 around coaxial cable 200. Additionally, the flowing of jacket 210 into notches 73 when the gripping member 70 is forced under body 20 provides additional resistance to coaxial cable 200 rotation within connector 10 once connector 10 is secured onto coaxial cable 200. It should be noted that virtually any number of notches 73 or shapes, configurations, arrangements or geometries may be used as further discussed below. The notches 73 result in about a 30-35% reduction in axial compressive force needed to drive shell 30 axially forward and, thereby, force gripping member 70 under body 20.

FIG. 5 is a cross-section of connector 10 and cable 200 shown in FIG. 4. FIG. 5 shows a section transversely cut through shell 30, body 20, cable 200, jacket 210, gripping member 70, notches 73, braided shield 208, outer conductor 206, dielectric 204, inner conductor 202. FIG. 5 illustrates the relationship of the different component parts of connector 10 and cable 200 when cable 200 is inserted in connector 10 and connector 10 is closed or engaged. As can be seen, a portion of gripping member 70 is shown as having flowed into notches 73.

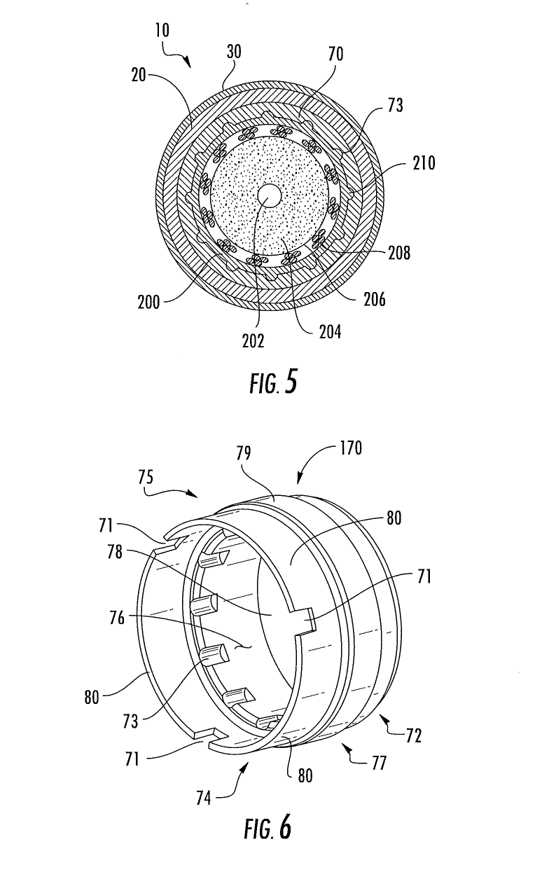

FIG. 6 is a detail, front perspective view of gripping member 170. Gripping member 170 is similar to gripping member 70 with the exception that first portion 75 has at least one slot 71 cut through first portion 75 from inner surface 76 through outer surface 79 and extending a certain length from front end 74 into first portion 75. Slots 71 define sections 80 therebetween. Slots 71 and sections 80 are configured to facilitate inward radial displacement of the first portion 75 by interaction with rearward facing tapered portion 27, so that first portion 75 is disposed in the annular cavity 60, between body 20 and post 50. In this regard, slots 71 and sections 80 further act to lower the direct axial compressive force required to close connector 10 around coaxial cable 200 in addition to notches 73.

Referring to FIG. 7 there is shown a detail front view of gripping member 70′. FIG. 7 is provided to illustrate that notches may be of different types or geometries. As non-limiting examples, FIG. 7 illustrates notches 173, 273 and 373. Notch 173 is shown as having an arcuate section configuration, which may be, generally, in the form of a semi-circle, but that is not necessary. Notch 273 is shown as having generally parallel sides connected by a perpendicular end as a partial rectangular cut configuration, while notch 373 is shown as having angled sides connected by an end, generally, in the form of a partial trapezoidal cut configuration. Gripping member 70 may have any combination of notch 73 configuration, for example, all notches 73 having the same configuration, or different notches 73 having different configuration. It is understood that notch 73 types and geometries are not intended to be limited to the configurations illustrated in FIG. 7.

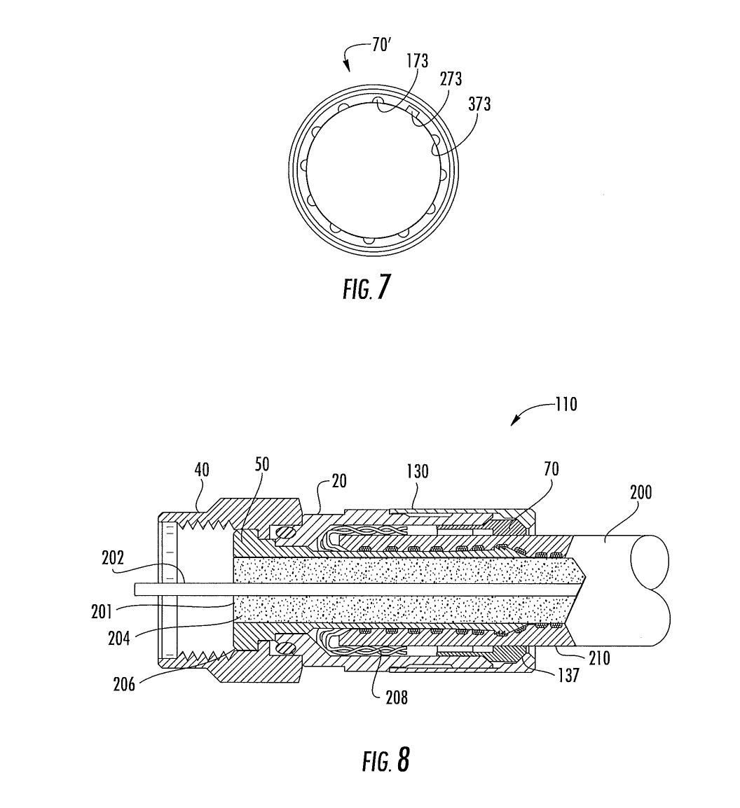

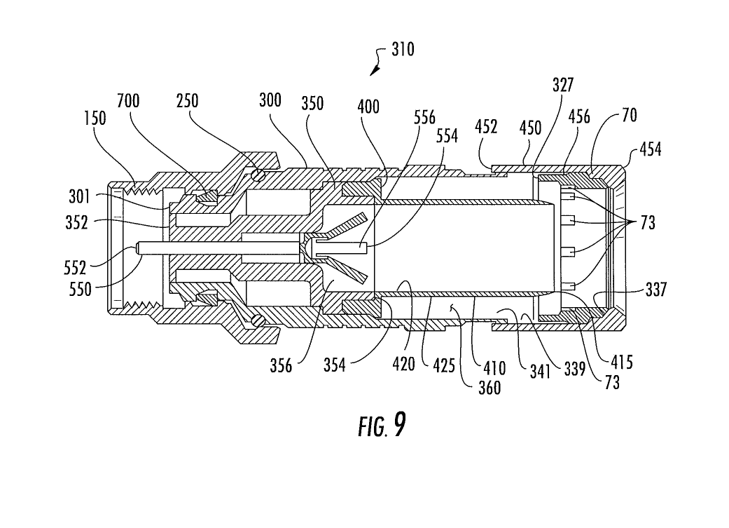

Referring now to FIG. 8, there is shown a cross-sectional view of connector 110. Connector 110 is similar to connector 10 with the exception that connector 110 does not have shell 30 with forward facing tapered portion 37. Instead, connector 110 includes shell 130 with forward facing straight portion 137. In a similar manner to forward facing tapered portion 37, as shell 130 is moved axially toward nut 40 forward facing straight portion 137 pushes gripping member 70 radially inward. Thus, as with connector 10, both rear and front ends 72, 74 of gripping member 70 are displaced radially inwardly in the forward position forming a dual grip against jacket 210.

FIG. 9 is a partial cutaway view along the centerline of an embodiment of connector 310. The connector 310 illustrated in FIG. 9 includes coupling nut 150, retaining ring 700, O-ring 250, generally cylindrical body 300, insulating member 350, post 400, shell 450, gripping member 70 with notches 73, pin 550, and optional seal ring 600. Coupling nut 150 is made from any suitable material, for example, metallic material, such as brass, and may be plated with a conductive, corrosion resistant material, such as nickel. Retaining ring 700 may be made from any suitable material, for example, a metallic material, such as heat treated beryllium copper. 0-Ring 250 may be made from any suitable material, for example, a rubber-like material, such as EPDM (Ethylene Propylene Diene Monomer).

Body 300 has first end 339, second end 301, and a central bore 341 and may be made from any suitable material, for example, a metallic material, such as brass, and may be plated with a conductive, corrosion resistant material, such as nickel. Insulating member 350 includes a front end 352, a rear end 354, and an opening 356 between the front and rear ends and may be made from any suitable material, for example, an insulative plastic material, such as high-density polyethylene or acetal. At least a portion of rear end 354 of insulating member 350 is in contact with at least a portion of post 400. Post 400 includes a tubular shank 410 having a rear end 415, an inner surface 420, and an outer surface 425 and may be made from any suitable material, for example, a metallic material, such as brass, and may be plated with a conductive, corrosion resistant material, such as tin. Outer surface 425 of tubular shank 410 and central bore 341 of body 300 define an annular cavity 360 there between.

Shell 450 surrounds first end 339 of body 300 and includes a front end 452, a rear end 454, and an inner surface 456 defining a longitudinal opening between front end 452 and rear end 454 and is axially movable over body 300 between a rearward position and a forward position, in the same manner as connector 10. Shell 450 may be made from any suitable material, for example, a metallic material, such as brass, and may be plated with a conductive, corrosion resistant material, such as nickel. Gripping member 70 is similar to gripping member 70 in connector 10. Pin 550 has a front end 552, a rear end 554, and a flared portion 556 at its rear end 554 to assist in guiding an inner conductor of a coaxial cable into physical and electrical contact with pin 550. Pin 550 is inserted into and substantially along opening 356 of insulating member 350 and may be made from any suitable material, for example, a metallic material, such as brass, and may be plated with a conductive, corrosion resistant material, such as tin. Pin 550 and insulating member 350 are rotatable together relative to body 300 and post 400. Seal ring 600 may be made from any suitable material, for example, a rubber-like material, such as silicone.

In a similar fashion as discussed with respect to connector 10, as shell 450 and post 50 are moved together axially by tool (not shown) front end 452 of shell 450 moves over an outside portion of body 300, causing gripping member 70 to move axially forward toward body 300 as well. First portion 75 of gripping member 70 is displaced radially inward by interaction with rearward facing tapered portion 327 at first end 339 and first portion 75 is disposed in the annular cavity 360, between body 300 and post 400. As can be seen, first portion 75 of the gripping member 70 is fully disposed in the annular cavity 360, and even a portion of the second portion 77 of gripping member 70 is also disposed within the annular cavity 360. Due to interaction with forward facing tapered portion 337 on the inside surface 456 of shell 450, gripping member 70 is pushed radially inward.

At least a portion of jacket 210 and braided shield 208 (not shown) are sandwiched between the gripping member 70 and the rear end 415 of the post 400. It is also, that in the forward position, the gripping member 70 forms a seal between jacket 210 and rear end 339 of body 300, sealing annular cavity 360 at rear end 339 of body 300. Also, in the forward position, gripping member 74 forms a seal between the body 300 and the inner surface 456 of the shell 450. Both rear and front ends 72, 74 of gripping member 70 are displaced radially inwardly in the forward position forming a dual grip against jacket 210. Additionally, in the forward position, a portion of jacket 210 flows into one or more of notches 73.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A gripping member for a coaxial cable connector, the gripping member comprising:
a front end and a rear end opposite the front end;
an outer surface and an inner surface defining a longitudinal hole extending between the front end and the rear end;
a first portion which terminates at the front end; and
a second portion which terminates at the rear end and comprising at least one notch which extends from the inner surface of second portion to a certain depth from inner surface,
wherein the gripping member is configured to secure a coaxial cable to a coaxial cable connector.

2. The gripping member of claim 1, wherein the coaxial cable connector comprises a body and wherein the gripping member secures the coaxial cable to the coaxial cable connector when at least part of the gripping member is forced under the body.

3. The gripping member of claim 2, wherein the coaxial cable connector comprises a shell movably attached to the body, and wherein the gripping member is press fit to an inside surface of the shell, and wherein the gripping member is forced under the body when driven axially forward by the shell.

4. The gripping member of claim 2, wherein the gripping member is configured to be displaced radially inwardly when the gripping member is forced under the body of a coaxial cable connector.

5. The gripping member of claim 2, wherein the front end of the gripping member is configured to be displaced radially inwardly when the gripping member is forced under the body of a coaxial cable connector.

6. The gripping member of claim 2, wherein the rear end of the gripping member is configured to be displaced radially inwardly when the gripping member is forced under the body of a coaxial cable connector.

7. The gripping member of claim 1, wherein the first portion comprises at least one slot cut through the first portion from the inner surface through the outer surface and extending a certain length from the front end into first portion.

8. The gripping member of claim 7, wherein the first portion comprises a plurality of slots.

9. The gripping member of claim 8, wherein the plurality of slots define sections there between.

10. The gripping member of claim 9, wherein the slots and the sections are configured to facilitate an inward radial displacement of the first portion when the gripping member is driven axially forward.

11. A connector for coupling an end of a coaxial cable to a terminal, the coaxial cable comprising an inner conductor, a dielectric surrounding the inner conductor, an outer conductor surrounding the dielectric, a braided shield surrounding the dielectric, and a jacket surrounding the braided shield, the connector comprising:
a body comprising a rear end, a front end, and an internal surface extending between the rear and front ends of the body, the internal surface defining a longitudinal hole;
a shell comprising a rear end, a front end surrounding at least a portion of the body, and an inner surface defining a longitudinal hole extending between the rear and front ends of the shell, the shell being axially movable over an outside portion the body between a rearward position and a forward position;
a post disposed at least partially within the longitudinal hole of the body, the post having a rear end, an inner surface and an outer surface, and wherein the outer surface of the post and the internal surface of the post define an annular cavity therebetween; and
a gripping member disposed within the longitudinal hole of the shell between the front and rear ends thereof, the gripping member comprising a front end, a rear end, an outer surface, an inner surface defining an opening therein, a first portion adjacent the front end, and a second portion adjacent the rear end, wherein the second portion comprises at least one notch which extends from the inner surface of second portion to a certain depth from inner surface,
wherein the gripping member is configured to secure a coaxial cable to a coaxial cable connector.

12. The connector of claim 11, wherein the gripping member secures the coaxial cable to the coaxial cable connector when at least part of the gripping member is forced under the body when driven axially forward by the shell.

13. The connector of claim 11, wherein the first portion comprises a plurality of slots cut through the first portion from the inner surface through the outer surface and extending a certain length from the front end into first portion, and wherein the plurality of slots define sections there between.

14. The connector of claim 11, wherein the slots and the sections are configured to facilitate an inward radial displacement of the first portion when the gripping member is driven axially forward.

15. The connector of claim 11, wherein, in the forward position, the inner surface of the deformable gripping ring, from the rear end to the front end thereof, contacts the jacket of the cable.

16. The connector of claim 15, wherein a portion of the jacket flows into one or more of the notches in the forward position.
